(19) United States
(12) Patent Application Publication
(10) Pub. No.: US 2007/0132754 A1
(43) Pub. Date: Jun. 14, 2007

(54) Method and apparatus for binary image classification and segmentation

(75) Inventors: Alexander V. Reshetov, Saratoga, CA (US); Alexei M. Soupikov, Nizhny Novgorod (RU); Alexander D. Kapustin, Nizhny Novgorod (RU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/301,699

(22) Filed: Dec. 12, 2005

(51) Int. Cl. G06T 15/00

(52) U.S. Cl. 345/419

(57) ABSTRACT

A method and apparatus for binary classification includes using signs of float values to detect different subgroups, detecting whether all entries in the group belong to the same subgroup, splitting original subgroup into uniform subgroups and classifying subgroups using array of float values. Coherency in groups of rays is detected by generating a group of rays, determining an originating point and a direction for each ray in the group, determining coherency of the group of rays and determining a group of rays as coherent as one in which all rays determined to travel in the same direction for each coordinate x, y, and z and determining a group of rays as incoherent otherwise and traversing the group of incoherent rays differently from the coherent group of rays.

### BACKGROUND

Implementations of the claimed invention generally may relate to schemes for binary image classification and segmentation and, more particularly, classification of rays during ray tracing.

A binary classification task may include separating given objects into two groups, one possessing certain properties and another not. Some typical applications may include decision making, image segmentation, data compression, computer vision, medical testing and quality control. Multiple approaches to binary classification exists, including, but are not restricted to decision trees, Bayesian networks, support vector machines, and neural networks. In some applications, classification is performed multiple times, sometimes millions, and binary decision includes selecting one of the two possibilities: 1) all objects in the group possess the certain property and 2) there are at least two objects in the group with different properties. In some implementations, an image processing problem may require deciding whether a group of pixels posses a certain property or not. For example, whether a group of pixels have a similar color or belong to the same object.

One technique for resolving global illumination problems involves tracing rays i.e. determining the intersection between rays and given geometry. Ray tracing is one conventional approach for modeling a variety of physical phenomena related to wave propagation in various media. For example, it may be used for computing illumination solution in photorealistic computer graphics, for complex environment channel modeling in wireless communication, aureal rendering in advanced audio applications, etc.

In a global illumination task, a three dimensional description of a scene (including geometrical objects, material properties, lights etc.) may be converted to a two dimensional representation suitable for displaying on a computer monitor or making a hard copy (printing or filming). It may be advantageous to process group of rays together, thus utilizing single instruction—multiple data (SIMD) capabilities of modern computers. Depending on certain binary classification of a given group of rays, different processing methods may be used. In some implementations, binary classification may be an initial step in ray tracing bundles of rays. In order to achieve real-time performance, which is required for numerous applications of global illumination, the classification step is preferably executed extremely fast.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates exemplary multiple rays traced from a camera through screen pixels to objects in a scene;

FIG. 2 illustrates an exemplary process of ray tracing;

FIG. 3 illustrates an exemplary process of separating incoherent ray groups;

FIG. 4 conceptually illustrates an exemplary group of 4×4 pixels with different directions of rays for each coordinate (x, y and z);

FIG. 5 illustrates an exemplary process of separating incoherent ray groups using Streaming SIMD Extension (S.S.E.) instructions;

FIG. 6 illustrates an exemplary process of detecting coherency in a given group of rays;

FIG. 7 illustrates an exemplary process of separating incoherent ray groups for further processing in an S.S.E. implementation;

FIG. 8 illustrates an exemplary computer system including image classification and segmentation logic.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

In some implementations, and for ease of explanation herein, embodiments of the invention are discussed using ray tracing terminology and examples. Embodiments of the invention are not limited to ray tracing. Neither is any particular SIMD implementation the only one possible. One skilled in the art could implement the described algorithms on different SIMD architectures.

Ray Casting

As used herein, ray casting, also referred to as ray tracing, may be understood to denote a technique for determining what is visible from a selected point along a particular line of sight. In some configurations, a ray may be a half line of infinite length originating at a point in space described by a position vector which travels from said point along a direction vector. Ray tracing may be used in computer graphics to determine visibility by directing one or more rays from a vantage point described by the ray's position vector along a line of sight described by the ray's direction vector. To determine the location of the nearest visible surface along that line of sight requires that the ray be effectively tested for intersection against all the geometry within the virtual scene and retain the nearest intersection.

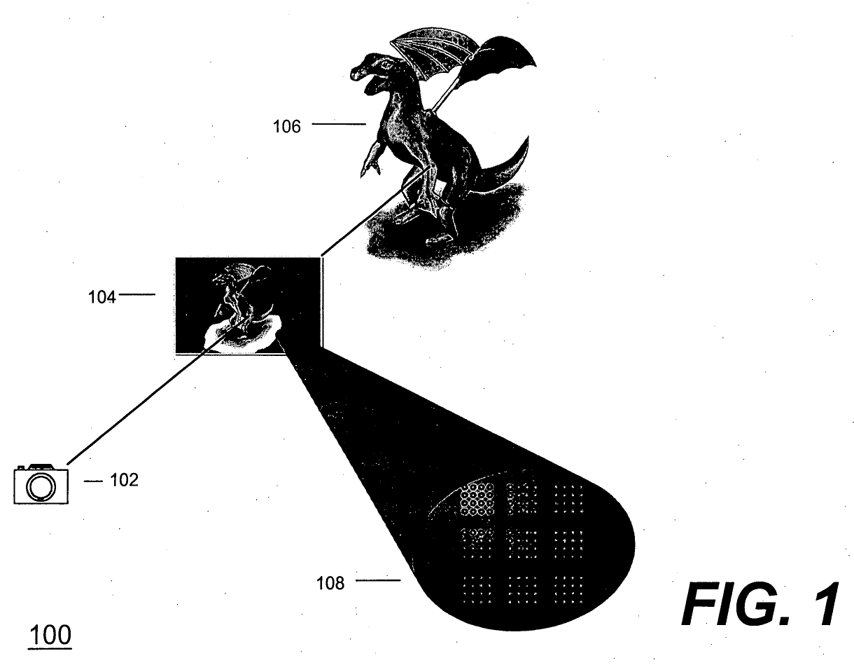

FIG. 1 illustrates one exemplary embodiment 100 of multiple rays traced from a camera 102 through screen pixels 104 to objects in a scene 106. As shown, nine groups of 4×4 rays 108 are shown geometrically separated. Although illustrated as being configured in a certain manner for ease of illustration, embodiment in FIG. 1 may be implemented in other configurations. In some implementations, depending on the complexity of the algorithm, secondary rays may be generated after the primary eye rays impinge some objects in the scene. Secondary rays may include but are not limited to shadow rays (shot in the direction of lights in the scene), reflected rays, refracted rays and some other types as well. In some implementations, ray tracing may be used to compute optically correct shadows, reflections, or refraction by generating secondary rays from the hit points along computed trajectories. Consequently, rendering of a typical scene may include tracing millions and millions of rays and multiple data streams may be processed simultaneously. In order to utilize these capabilities, it may advantageous to process groups of rays together. Processor-specific instructions, such as Streaming Single Instruction/Multiple Data (SIMD) Extension (S.S.E.) instructions, may allow simultaneous processing of four float or integer numbers.

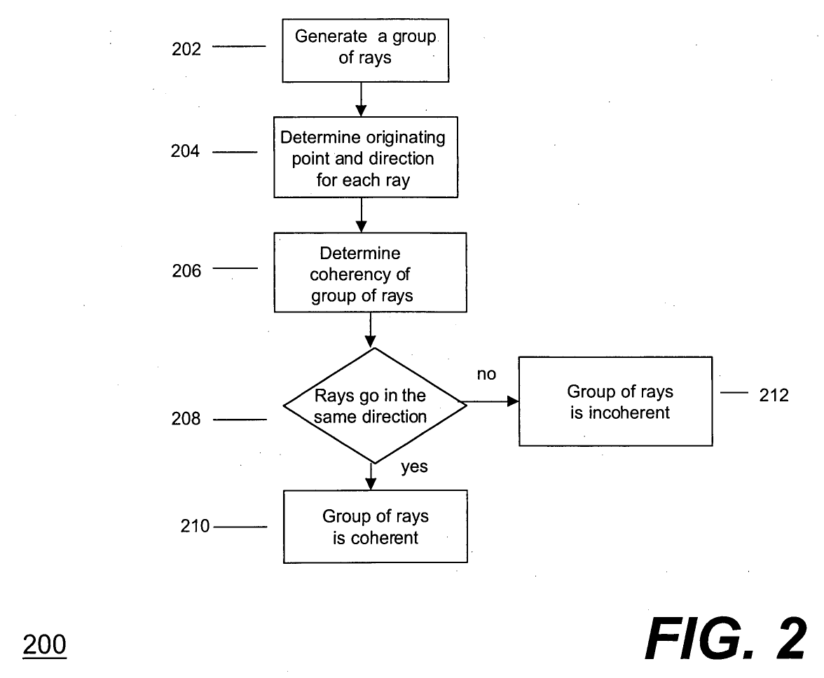

FIG. 2 illustrates an example process 200 of ray tracing. Although FIG. 2 may be described with regard to embodiment 100 in FIG. 1 for ease and clarity of explanation, it should be understood that process 200 may be performed by other hardware and/or software implementations.

Groups of rays (ray casting) may be initially generated (act 202). In some implementations, rays which travel through adjacent pixels are grouped together as in FIG. 1. Traversal algorithms may be executed more efficiently when rays travel through a scene mostly together. However, after a few interactions, these rays may loose coherency, especially when rays in the group intersect with different objects.

An originating point (eye position) and a direction for each ray may be determined (act 204). In some implementations, the originating point may be expressed as \vec{o}=(ox,oy,oz) and the direction may be expressed as \vec{d}=(dx,dy,dz). An eye ray may originate at the center of projection of the camera and travel through a pixel of the image plane. Numerical subscripts may be used to distinguish different coordinates (instead of x, y, and z). For example, the ray direction may be expressed as \vec{d}=(d[0],d[1],d[2]). Subscript i will also be used to indicate different rays in the group (like i=1 . . . 16 for all rays in group of 4×4 rays).

The coherency of the groups of rays may be determined (act 206). In some implementations, the coherency may be determined in accordance with equation (1) as follows:
(all dxᵢ>0 or all dxᵢ<0) and (all dyᵢ>0 or all dyᵢ<0) and (all dzᵢ>0 or all dzᵢ<0) Eq. (1)
where i goes from 1 to N, where N=number of rays in the packet

The group may be determined coherent (act 210) if all the rays are determined to travel in the same direction (either positive or negative) for each coordinate x, y, and z (act 208). The group may be considered incoherent (act 212) if all rays do not travel in the same direction for each coordinate x, y, and z (act 208). In some implementations, incoherent groups of rays may be traversed differently from coherent groups of rays. Also, exact equality may not be defined in Eq. (1). For example, a group in which some direction coordinates are zero may be processed as an incoherent group.

Separation Algorithm

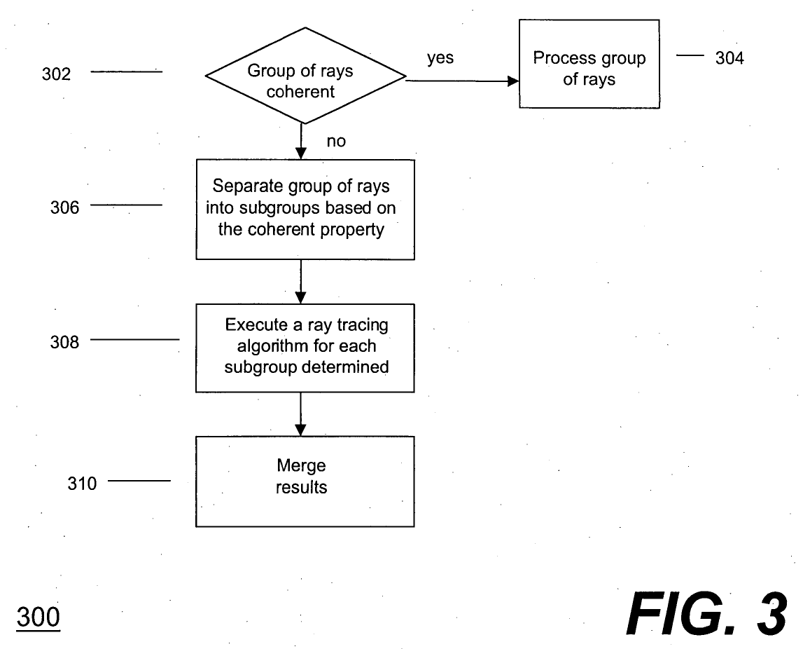

In some implementations, the majority of packets of rays which are created in global illumination tasks will be coherent. However, when there is a large number of rays in a packet, some of the rays in the packet may travel in different directions i.e. be incoherent. As shown in FIG. 1, packets of size sixteen, grouped four rows of four pixels together may be utilized. For illustrative purposes, FIG. 3 illustrates an example process 300 of separating incoherent ray groups using this packet configuration. Although FIG. 3 may be described with regard to embodiment 100 in FIG. 1 for ease and clarity of explanation, it should be understood that process 100 may be performed by other hardware and/or software implementations.

It is initially determined whether a group is coherent (act 302). In some implementations, this may be determined in accordance with Eq. (1) above or some other means.

If it is determined that the group is coherent (act 302), the group may be processed as a whole (act 304).

If it is determined that the group is incoherent (act 302), the group is separated into subgroups based on the coherent property (act 306). Since each coordinate in the example may yield two separate directions, it is possible to have eight different subgroups.

For each subgroup (act 308), a ray tracing algorithm may be executed independently (act 310).

The results are then merged (act 310). This step includes copying intersection data, which may include distance to the intersection point and identifier of the intersected object for each ray, from individual subgroups to the original group.

One skilled in the art will recognize that embodiments of algorithm 300 may be implemented in any high level language and in a way to support the amount of data processed during ray tracing.

S.S.E. Implementation

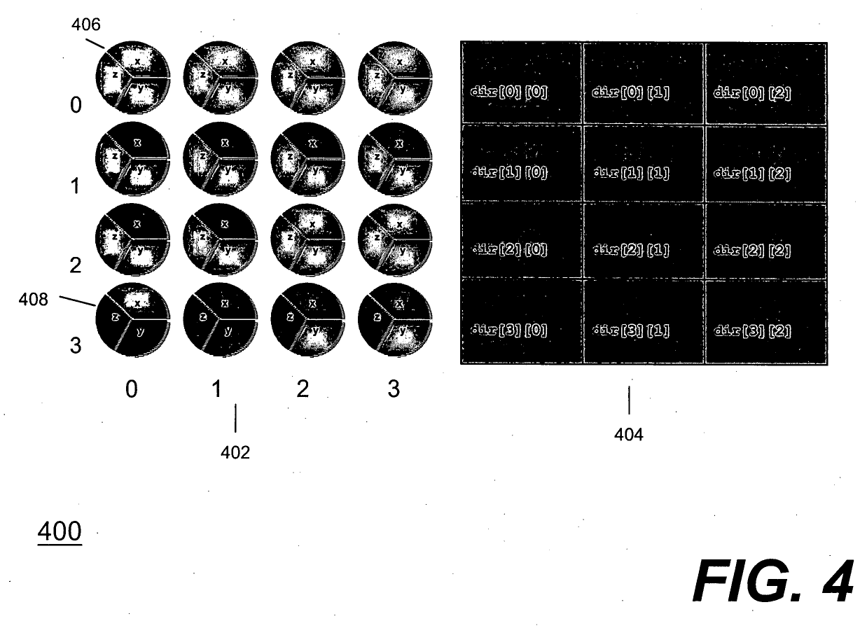

FIG. 4 conceptually illustrates an exemplary group 400 of 4×4 pixels 402 with different directions of rays for each coordinate (x, y and z). In particular, directional signs for a 4×4 group of rays and its compact S.S.E. layout 404 are illustrated. Regions 406 represent positive direction, regions 408 represent negative direction.

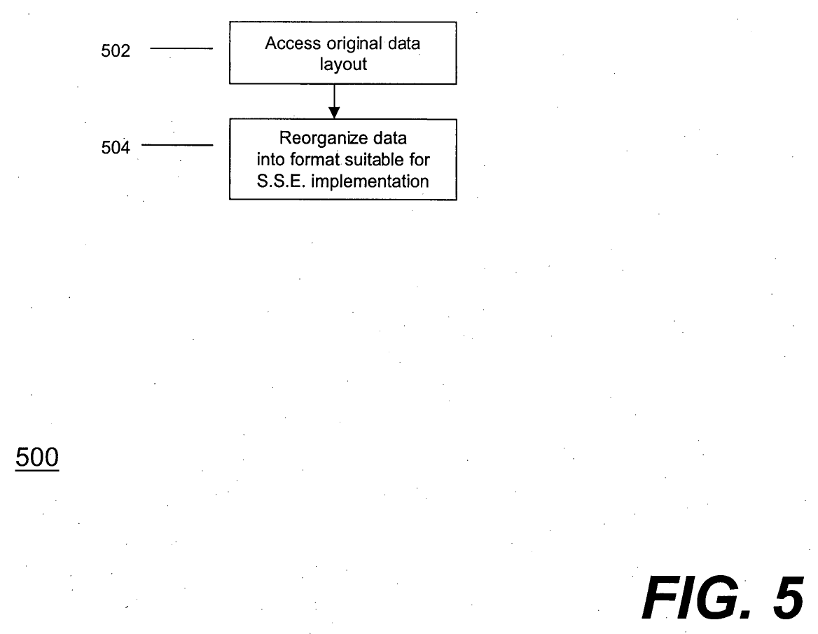

FIG. 5 illustrates an example process 500 of reorganizing rays direction data into format suitable for S.S.E. instructions. Although FIG. 5 may be described with regard to embodiment 400 in FIG. 4 for ease and clarity of explanation, it should be understood that process 500 may be performed by other hardware and/or software implementations. For example, in addition to accelerating ray tracing, other applications which require processing of large amounts of data, such as image segmentation and classification problems, may benefit from it as well.

The data may be initially stored in a format unsuitable for a S.S.E. implementation (act 502). In some implementations, each origin and direction vector may be represented as three float numbers (one for each coordinate). Based on this, all vectors may be stored sequentially (act 502) as follows:

| | | | | | | | | | | | |
|---|---|---|---|---|---|---|---|---|---|---|---|
| dx₁ | dy₁ | dz₁ | dx₂ | dy₂ | dz₂ | dx₃ | dy₃ | dz₃ | dx₄ | dy₄ | dz₄ |

In this implementation, the layout represents the storage of 4 direction vectors \vec{d}₁, \vec{d}₂, \vec{d}₃, and \vec{d}₄ (first row in 4×4 group). However, in some implementations, this format may not be ideal for four-way SIMD processing since each S.S.E. number may contain elements of different vectors ( (dx₁, dy₁, dz₁, dx₂) in the first one and so on). In order to fully utilize processing power of a S.S.E. unit, the data may be rearranged (act 504) as follows:

| dir[0] [0] | | | | dir[0] [1] | | | | dir[0] [2] | | | |
|---|---|---|---|---|---|---|---|---|---|---|---|
| dx₁ | dx₂ | dx₃ | dx₄ | dy₁ | dy₂ | dy₃ | dy₄ | dz₁ | dz₂ | dz₃ | dz₄ |

Three homogeneous S.S.E. vectors dir[0][0], dir[0][1], and dir[0][2] are shown above. In particular, in dir[i][j], index i represents a row (from 0 to 3) and index j represents a coordinate (x, y, and z).

In one implementation, the data 404 for 16 rays on FIG. 4 may be stored continuously in memory so dir[0][2] is immediately followed by dir[1][0] and so on. Each dir[i][i] number may occupy 16 bytes (4×32 bits) so a total of 16×3×4=192 bytes may be required to store the direction vectors for the whole 4×4 group. According to process 300 described above and shown in FIG. 3, it is initially determined whether all the rays in the packet are coherent. Referring to FIG. 4, this would correspond to all x, y, and z sectors having either regions 406 or 408.

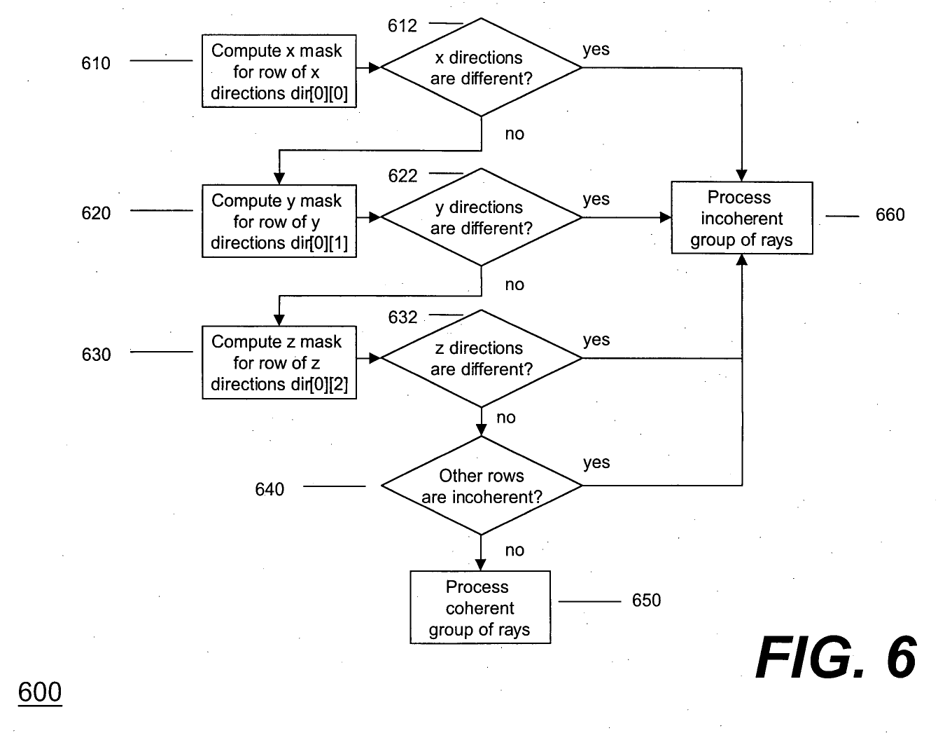

FIG. 6 illustrates an example process 600 of testing group of rays for coherency using S.S.E. instructions and implements embodiment 206 on FIG. 2. Although FIG. 6 may be described with regard to embodiment 400 in FIG. 4 for ease and clarity of explanation, it should be understood that process 600 may be performed by other hardware and/or software implementations. For example, the process may be implemented using various operations, including but not limited to MOVMSKPS (create four bit mask of sign bits) operation. For illustrative purposes, S.S.E. intrinsic instructions such as that disclosed in IA-32 Intel® Architecture Software Developer's Manual, http://www.intel.com/design/Pentium4/manuals/25366513.pdf may be used.

Process 600 checks x, y, and z directions of all rays in a given packet. For ease and clarity of explanation, this is described for a packet that contains 4 rows of 4 rays each. It should be understood that process 600 may be implemented for larger or smaller groups of rays.

Initially, a four bit mask cm[0] may be computed, which stores signs of x directions of the first row of rays (act 610). This may be accomplished as
cm[0]=_mm_movemask_ps(dir[0][0]);

Mask cm[0] may then tested to detect coherency of x directions (embodiment 612). If all x directions are positive (in which case cm[0] is equal to 0) or negative (cm[0] is 15) then control is passed to act 620. Otherwise, the whole group of rays may be processed as an incoherent one (act 660 which corresponds to embodiment 212 on FIG. 2.).

Similarly, mask for y directions may be computed as
cm[1]=_mm_movemask_ps(dir[0][1])
in act 620 and a coherency test may be performed in act 622.

For z directions, mask may be computed as
cm[2]=_mm_movemask_ps(dir[0][2])
in act 630 and a coherency test may be performed in act 632.

For all other rows (for example, represented by dir[1], dir[2], and dir[3]), direction masks may be compared with already found masks cm[j] for the first row. In order for the whole group to be coherent, these masks for each direction have to be the same. It may be accomplished with the following test (for x directions):

if (cm[0]!=_mm_movemask_ps(dir[1] [0]))
goto process_incoherent_group;
// 660
if (cm[0]!=_mm_movemask_ps(dir[2] [0]))
goto process_incoherent_group;
// 660
if (cm[0]!=_mm_movemask_ps(dir[3] [0]))
goto process_incoherent_group;
// 660

Similar tests may be performed for the y direction (using cm[1]) and z direction (cm[2]). These calculations may be done in act 640. If group is found to be incoherent, execution continues to act 660, otherwise group is processed as coherent one in act 650.

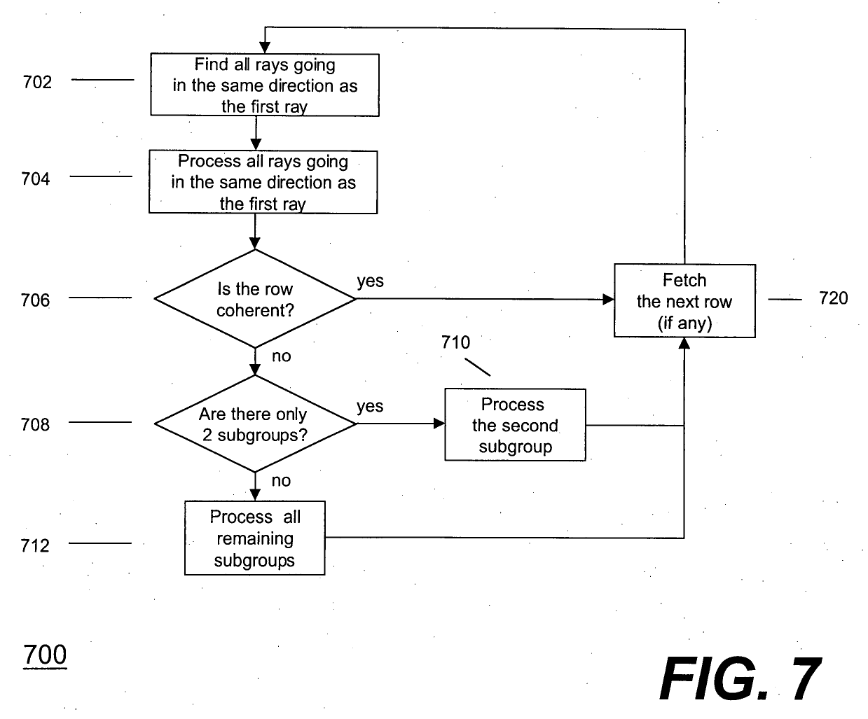

FIG. 7 illustrates an example process 700 of separating incoherent ray groups using S.S.E. instructions for further processing in an S.S.E. implementation. This corresponds to embodiment 660 on FIG. 6. Although FIG. 7 may be described with regard to embodiment 400 in FIG. 4 for ease and clarity of explanation, it should be understood that process 700 may be performed by other hardware and/or software implementations. For exemplary purposes, this process is executed for each row of a packet of rays such as the 4×4 packet of rays illustrated in FIG. 4.

Process 700 may be executed on a row by row process basis. Each row may be split into coherent subgroups. This may be accomplished by creating a mask (logical S.S.E. value), which contains 1's for rays belonging to the current subgroup and 0's for other rays. It is possible that all 4 rays in the row will go in the different directions, thus requiring creation of 4 subgroups. It is also possible that all rays in some row will be coherent, so only one subgroup may be created. One common situation is one when there are either one or two subgroups in the row. Process described below and illustrated in FIG. 7 may address this common situation. Referring to FIG. 4, rows 0 and 1 are coherent (all positive directions for row 0 and matching directions for row i), row 2 has two subgroups and row 3 contains three subgroups.

For each row, in act 702 it is determined which rays go in the same direction as the first ray in the row (which corresponds to index 0). This may be accomplished by comparing individual masks for each coordinate x, y, and z with appropriate mask for the first ray (obtained by using shuffling operator below). Four identical values returned, which may then be compared with the full mask. This may be accomplished by executing the following 6 operations:

m[0] = _mm_cmpge_ps(dir[i] [0], _mm_setzero_ps( )); // x
m[1] = _mm_cmpge_ps(dir[i] [1], _mm_setzero_ps( )); // y
m[2] = _mm_cmpge_ps(dir[i] [2], _mm_setzero_ps( )); // z
m[0] = _mm_xor_ps(m[0], _mm_shuffle_ps(m[0], m[0], 0));
m[1] = _mm_xor_ps(m[1], _mm_shuffle_ps(m[1], m[1], 0));
m[2] = _mm_xor_ps(m[2], _mm_shuffle_ps(m[2], m[2], 0));

Consequently, for all directions that match the direction of the first ray, appropriate entries in logical variables (m[0] for x direction, m[1] for y, and m[2] for z) will be exactly zero (contain all 0's).

All rays which are determined to go in the same direction as the first ray in act 702 may be processed in act 704. This may be performed for all rays for which variable mact holds 1's:

mall = _mm_or_ps(_mm_or_ps(m[0], m[1]),
m[2]); // 1's if different from 1st
mact = _mm_andnot_ps(mall, sse_true);
// sse_true contains all 1's

If there are no incoherent rays in the row, as determined in act 706, the next row may be fetched (act 720). This may be determined by testing sign bits of variable mall described above by comparing_mm_movemask_ps(mall) with 0. If it is true then there are no incoherent rays in the given row.

Otherwise, if there are incoherent rays determined in act 706, it is determined whether there are exactly 2 subgroups in the row which differ only in one direction (act 708). This may be accomplished by verifying that only one _mm_movemask_ps (m[j]) value is non-zero for j=1,2,3.

If there are exactly two sub-groups detected in act 708, second subgroup is processed in act 710. For example, this may be done for all rays for which variable mall holds 1's.

Otherwise (act 712), all possible subgroups in the given row may be identified and processed. This may be accomplished by constructing various masks using values m[0], m[1], and m[2] and using these masks in processing the given row, but only if there are non-zero components in the mask. These are 7 mask values, yielding all possible sub-groups (in addition to one defined above):

mact = _mm_and_ps(_mm_and_ps (m[0], m[1]), m[2]);
mact = _mm_and_ps(_mm_andnot_ps (m[0], m[1]), m[2]);
mact = _mm_and_ps(_mm_andnot_ps (m[1], m[0]), m[2]);
mact = _mm_and_ps(_mm_andnot_ps (m[2], m[0]), m[1]);
mact = _mm_andnot_ps(m[0], _mm_andnot_ps(m[2], m[1]));
mact = _mm_andnot_ps(m[0], _mm_andnot_ps (m[1], m[2]));
mact = _mm_andnot_ps(m[1], _mm_andnot_ps (m[2], m[0]));

Other logical expressions yielding all possible subgroups are also feasible.

In typical implementations, process 700 effectively handles two of the most prevalent cases:
1) All 4 rays in a row are coherent (requires processing of only one subgroup).
2) Only one coordinate (x, y, or z) yields incoherent values. In this case two subgroups will be processed, but the exhaustive computations defined by masks in will be avoided.
   System

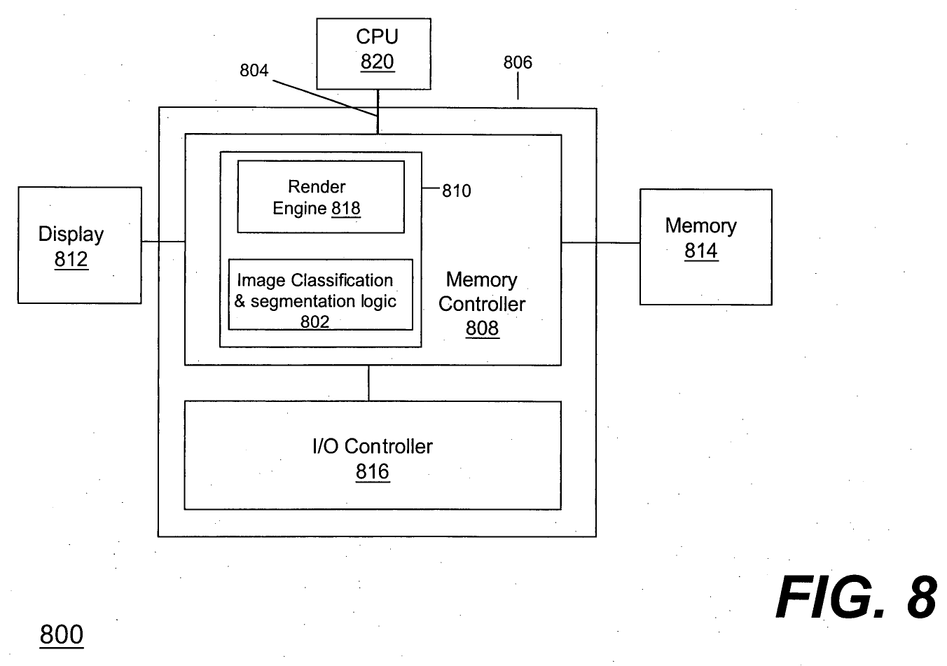

FIG. 8 illustrates an exemplary computer system 800 including image classification and segmentation logic 802. Image classification and segmentation logic 802 may be one of the processes noted above. Representatively, computer system 800 comprises a processor system bus 804 for communicating information between processor (CPU) 820 and chipset 806. As described herein, the term “chipset” may be used in a manner to collectively describe the various devices coupled to CPU 820 to perform desired system functionality. In some implementations, CPU 820 may be a multicore chip multiprocessor (CMP).

Representatively, chipset 806 includes memory controller 808 including an integrated graphics controller 810. In some implementations, graphics controller 810 may be coupled to display 812. In other implementations, graphics controller 810 may be coupled to chipset 806 and separate from memory controller 808, such that chipset 806 includes a memory controller separate from graphics controller. The graphics controller may be in a discrete configuration. Representatively, memory controller 808 is also coupled to main memory 814. In some implementations, main memory 814 may include, but is not limited to, random access memory (RAM), dynamic RAM (DRAM), static RAM (SRAM), synchronous DRAM (SDRAM), double data rate (DDR) SDRAM (DDR-SDRAM), Rambus DRAM (RDRAM) or any device capable of supporting high-speed buffering of data.

As further illustrated, chipset 806 may include an input/output (I/O) controller 816. Although chipset 806 is illustrated as including a separate graphics controller 810 and I/O controller 816, in one embodiment, graphics controller 810 may be integrated within CPU 820 to provide, for example, a system on chip (SOC). In an alternate embodiment, the functionality of graphics controller 810 and I/O controller 816 are integrated within chipset 806.

In one embodiment, image classification and segmentation logic 802 may be implemented within computer systems including a memory controller integrated within a CPU, a memory controller and I/O controller integrated within a chipset, as well as a system on-chip. Accordingly, those skilled in the art recognize that FIG. 8 is provided to illustrate one embodiment and should not be construed in a limiting manner. In one embodiment, graphics controller 810 includes a render engine 818 to render data received from image classification and segmentation logic 802 to enable display of such data.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the invention.

Although systems are illustrated as including discrete components, these components may be implemented in hardware, software/firmware, or some combination thereof. When implemented in hardware, some components of systems may be combined in a certain chip or device. Although several exemplary implementations have been discussed, the claimed invention should not be limited to those explicitly mentioned, but instead should encompass any device or interface including more than one processor capable of processing, transmitting, outputting, or storing information. Processes may be implemented, for example, in software that may be executed by processors or another portion of local system.

For example, at least some of the acts in FIGS. 2, 3 5, 6 and 7 may be implemented as instructions, or groups of instructions, implemented in a machine-readable medium. No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method for binary classification, comprising
using signs of float values to detect different subgroups;
detecting whether all entries in the group belong to the same subgroup;
splitting original subgroup into uniform subgroups; and
classifying subgroups using array of float values.

2. The method claimed in claim 1, wherein SIMD instructions are provided for binary classification.

3. The method claimed in claim 1, wherein detecting whether all entries in the group belong to the same subgroup further comprises:
detecting whether all entries in the group have the same sign.

4. The method claimed in claim 1, further comprising:
detecting coherency in groups of rays.

5. The method claimed in claim 4, wherein detecting coherency in groups of rays, further comprises:
generating a group of rays;
determining an originating point and a direction for each ray in the group;
determining coherency of the group of rays; and
determining a group of rays as coherent as one in which all rays determined to travel in the same direction for each coordinate x, y, and z; and
determining a group of rays as incoherent otherwise and traversing the group of incoherent rays differently from the coherent group of rays.

6. The method claimed in claim 5, wherein determining coherency of the group of rays further comprises:
determining coherency of the group of rays in accordance with (all dxᵢ>0 or all dxᵢ<0) and (all dyᵢ>0 or all dyᵢ<0) and (all dzᵢ>0 or all dzᵢ<0) where i goes from 1 to N, where N=number of rays in the packet.

7. The method claimed in claim 5, wherein determining a group of rays as incoherent otherwise and traversing the group of incoherent rays differently from the coherent group of rays further comprises:
determining a group of rays as incoherent otherwise and traversing the group of incoherent rays differently from the coherent group of rays if in the group some direction coordinates are zero.

8. The method claimed in claim 5, wherein determining a group of rays as incoherent otherwise and traversing the group of incoherent rays differently from the coherent group of rays further comprises:
separating the group into subgroups based on the coherent property.

9. The method claimed in claim 5, wherein determining a group of rays as incoherent and traversing the group of incoherent rays differently from the coherent group of rays further comprises:
merging the results for different subgroups.

10. The method claimed in claim 1, wherein splitting original subgroup into uniform subgroups further comprises:
separating incoherent groups using S.S.E. instructions.

11. The method claimed in claim 5, wherein determining an originating point and a direction for each ray in the group further comprises:
reorganizing the data into a format for a S.S.E. implementation wherein each origin and direction vector may be represented as three S.S.E. numbers for each four rays.

12. The method claimed in claim 3, wherein detecting whether all entries in the group belong to the same subgroup using signs of float values further comprises:
detecting if all sign bits for the first row in the group are the same for each entry;
comparing sign bits for other rows in the original group with the first one; and
using comparison results to detect the coherent group.

13. The method claimed in claim 1, wherein splitting original subgroup into uniform subgroups using S.S.E. instructions further comprises:
processing group on row by row basis;
determining which entries in the row belong to the same subgroup as the first entry in the row;
processing all entries that belong to the same subgroup as the first entry in the row as one subgroup;
detecting if there are one, two or more subgroups in the, row;
processing the second subgroup in case there are only two subgroups; and
using logical masks to designate all possible subgroups in the group in case there are more then two subgroups.

14. The method claimed in claim 1, wherein splitting original subgroup into uniform subgroups using S.S.E. instructions further comprises:
identifying the most prevalent cases and optimizing algorithm to handle them effectively.

15. The method claimed in claim 13, wherein splitting original subgroup into uniform subgroups using S.S.E. logical masks to designate all possible subgroups in the group further comprises:
using array of S.S.E. values to find all possible logical masks; and
using only S.S.E. operations for these computations.

16. An article of manufacture having a machine accessible medium including associated data, wherein the data, when accessed, results in the machine performing:
using signs of float values to detect different subgroups;
detecting whether all entries in the group belong to the same subgroup;
splitting original subgroup into uniform subgroups; and
classifying subgroups using array of float values.

17. The article of manufacture claimed in claim 16, further comprising detecting coherency in groups of rays.

18. The article of manufacture claimed in claim 17, wherein detecting coherency in groups of rays further comprises:
generating a group of rays;
determining an originating point and a direction for each ray in the group;
determining coherency of the group of rays; and
determining a group of rays as coherent as one in which all rays determined to travel in the same direction (either positive or negative) for each coordinate x, y, and z; and
determining a group of rays as incoherent otherwise and traversing the group of incoherent rays differently from the coherent group of rays.

19. A system comprising:
a graphics controller including binary classification logic to use signs of float values to detect different subgroups, detect whether all entries in the group belong to the same subgroup, split original subgroup into uniform subgroups, and classify subgroups using array of float values.

20. The system claimed in claim 19, wherein binary classification logic further comprises detecting coherency in groups of rays, including generating a group of rays, determining an originating point and a direction for each ray in the group, determining coherency of the group of rays, and determining a group of rays as coherent as one in which all rays determined to travel in the same direction (either positive or negative) for each coordinate x, y, and z.
